(19) United States
(12) Patent Application Publication
(10) Pub. No.: US 2024/0017729 A1
(43) Pub. Date: Jan. 18, 2024

(54) VEHICLE AND VEHICLE LOAD DISTRIBUTION IDENTIFICATION METHOD, APPARATUS, MEDIUM AND ELECTRONIC DEVICE

(71) Applicant: BYD COMPANY LIMITED, Shenzhen (CN)

(72) Inventors: Guanwen WANG, Shenzhen (CN); Yinsheng LIAO, Shenzhen (CN); Hongzhou ZHANG, Shenzhen (CN)

(21) Appl. No.: 18/373,164

(22) Filed: Sep. 26, 2023

Related U.S. Application Data
(63) Continuation of application No. PCT/CN2022/096177, filed on May 31, 2022.

(30) Foreign Application Priority Data
Jun. 21, 2021 (CN) 202110687601.4

(51) Int. Cl. B60W 40/13; B60W 40/105; B60W 40/107; B60W 40/11

(52) U.S. Cl. CPC B60W 40/13; B60W 40/105; B60W 40/107; B60W 40/11; B60W 2040/1307; B60W 2520/105; B60W 2520/16; B60W 2530/10

(57) ABSTRACT

A method for identifying vehicle load distribution includes the steps of: detecting a speed and longitudinal acceleration of the vehicle; when the longitudinal acceleration is less than an acceleration threshold, acquiring a driving force of the vehicle; obtaining, by a processor, a pitch angle of the vehicle according to the driving force and the vehicle speed; and obtaining, by the processor, load distribution of the vehicle according to the pitch angle.

### CROSS-REFERENCE TO RELATED APPLICATION

This application is a Continuation application of International Patent Application No. PCT/CN2022/096177, filed on May 31, 2022, which is based on and claims priority to and benefits of Chinese Patent Application No. 202110687601.4, filed on Jun. 21, 2021. The entire content of all of the above-referenced applications is incorporated herein by reference.

### FIELD

The present disclosure relates to the technical field of vehicles, and particularly to a vehicle and a method and apparatus for identifying vehicle load distribution, and a non-transitory computer-readable storage medium and an electronic device.

### BACKGROUND

When measuring the load distribution of the front and rear axles of a vehicle, it is generally necessary to install a load sensor or at least two body height sensors at the suspension. In order to avoid installation of the aforementioned sensors at the suspension, in the related art, it is proposed to indirectly estimate the front and rear load levels according to deformation of the tire under different loads. As shown in FIG. 1, in step 1, the wheel speed signal that may come from the wheel speed sensor of the antilock braking system is obtained. In steps 2 and 3, the wheel speed signals (e.g., frequency spectrum) of the front and rear wheels are analyzed, and in step 4, the resonance energies are compared and the load distribution is estimated. FIG. 2 shows the case where the resonance energy varies with the load in an example. Curve 5 represents the resonance energy characteristic value (resonance energy/resonance frequency) of the rear axle, and Curve 6 represents the resonance energy characteristic value of the front axle. The load of the rear axle of the vehicle starts to increase at time 7, and then increase of the characteristic value of the rear axle is detected, thus identifying the change of load distribution.

However, this technology needs to identify the resonance spectrum characteristics of the front and rear wheels, which involves a large amount of calculation, and the rear wheels of most of the front-wheel-drive vehicle models lack apparent resonance characteristics (or the apparent resonance characteristics can only be identified in some vehicle speed segments), so the corresponding resonance energy characteristic values cannot be obtained. Therefore, this technology has a rather limited application range.

### SUMMARY

The present disclosure solves at least one of technical problems in the related art. at a first aspect, the present disclosure provides a method for identifying vehicle load distribution, to reduce the cost of vehicle load distribution identification and extend the application range.

In a second aspect, the present disclosure provides a vehicle load distribution identification apparatus.

In a third aspect, the present disclosure provides a non-transitory computer-readable storage medium.

In a fourth aspect, the present disclosure provides an electronic device.

In a fifth aspect, the present disclosure provides a vehicle.

An embodiment in a first aspect of the present disclosure provides a vehicle load distribution identification method including the steps of: detecting a speed and longitudinal acceleration of the vehicle; acquiring a driving force of the vehicle when the longitudinal acceleration is less than an acceleration threshold; obtaining, by a processor, a pitch angle of the vehicle according to the driving force and the vehicle speed; and obtaining, by the processor, load distribution of the vehicle according to the pitch angle.

According to an embodiment of the present disclosure, the obtaining the pitch angle of the vehicle according to the driving force and the vehicle speed includes: obtaining a reference driving force corresponding to the vehicle speed according to the vehicle speed and acquiring a reference pitch angle; and obtaining the pitch angle according to the driving force, the reference driving force and the reference pitch angle.

According to an embodiment of the present disclosure, the obtaining the pitch angle according to the driving force, the reference driving force and the reference pitch angle includes: calculating a first difference between the reference driving force and the driving force; acquiring the mass of the vehicle and calculating a first ratio of the first difference to the mass; and summing the first ratio with the reference pitch angle to obtain the pitch angle.

According to an embodiment of the present disclosure, the obtaining the pitch angle according to the driving force, the reference driving force and the reference pitch angle includes: calculating an average of a plurality of the driving forces to obtain an average driving force; calculating a second difference between the reference driving force and the average driving force; acquiring the mass of the vehicle and calculating a second ratio of the second difference to the mass; and summing the second ratio with the reference pitch angle to obtain the pitch angle.

According to an embodiment of the present disclosure, the obtaining load distribution of the vehicle according to the pitch angle includes: acquiring a front-rear wheelbase, the stiffness of a front suspension and the stiffness of a rear suspension of the vehicle; and calculating the load distribution of the vehicle according to the pitch angle, the front-rear wheelbase, the stiffness of the front suspension and the stiffness of the rear suspension.

According to an embodiment of the present disclosure, the load distribution of the vehicle is calculated by the following equation:

$$θ = \frac{{F}_{2} / {k}_{2} - {F}_{1} / {k}_{1}}{L} ,$$

where θ is the pitch angle, L is the front-rear wheelbase, k₁ is the stiffness of the front suspension, k₂ is the stiffness of the rear suspension, and F₁ is a front axle load, and F₂ is a rear axle load of the vehicle.

An embodiment in a second aspect of the present disclosure provides a vehicle load distribution identification apparatus, including: a first acquisition module configured to detect a speed and longitudinal acceleration of the vehicle; a second acquisition module configured to acquire an driving force of the vehicle when the longitudinal acceleration is less than an acceleration threshold; a calculation module configured to obtain an pitch angle of the vehicle according to the driving force and the vehicle speed; and an identification module configured to obtain load distribution of the vehicle according to the pitch angle.

An embodiment in a third aspect of the present disclosure provides a computer-readable storage medium having a computer program stored thereon, where when executed by a processor, the computer program implements the vehicle load distribution identification method described above.

An embodiment in a fourth aspect of the present disclosure provides an electronic device, including a memory and a processor, the memory having a computer program stored thereon. When executed by the processor, the computer program implements the vehicle load distribution identification method described above.

An embodiment in a fifth embodiment of the present disclosure provides a vehicle including the vehicle load distribution identification apparatus according to the embodiment described above or the electronic device according to the embodiment described above.

With the vehicle, the method, the apparatus, the medium, and the electronic device for identifying vehicle load distribution according to the embodiments of the present disclosure, the difference between the front and rear axle loads of the vehicle can be identified by calculating the pitch angle of the vehicle, so that the vehicle load distribution can be identified without installing dedicated sensors such as a load sensor and a vehicle body height sensor at the vehicle suspension, which reduces the cost for identifying vehicle load distribution and allows a wide range of applications to all vehicle models.

Some of additional aspects and advantages of the present disclosure will be given in the following description, and become apparent from the following description, or be learned from practices of the present disclosure.

### BRIEF DESCRIPTION OF THE DRAWINGS

FIG. 1 is a schematic structural diagram of vehicle load distribution identification in the related art;

FIG. 2 is a schematic diagram of variation of the resonance energy with the load in the related art;

FIG. 3 is a flowchart of a vehicle load distribution identification method according to an embodiment of the present disclosure;

FIG. 4 is a schematic structural diagram of vehicle load distribution identification according to an embodiment of the present disclosure;

FIG. 5 is a schematic diagram of the pitch angle versus the front and rear axle load of the vehicle according to an embodiment of the present disclosure;

FIG. 6 is a schematic diagram of the measurement of an acceleration sensor versus the longitudinal acceleration of the vehicle according to an embodiment of the present disclosure;

FIG. 7 is a structural block diagram of a vehicle load distribution identification apparatus according to an embodiment of the present disclosure;

FIG. 8 is a structural block diagram of an electronic device according to an embodiment of the present disclosure;

FIG. 9 is a structural block diagram of a vehicle according to an embodiment of the present disclosure; and

FIG. 10 is a structural block diagram of a vehicle according to another embodiment of the present disclosure.

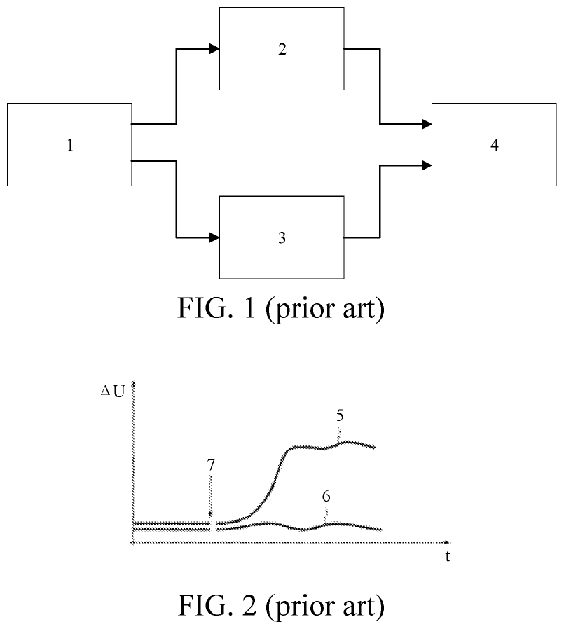

### DETAILED DESCRIPTION

Embodiments of the present disclosure are described in detail below, and examples of the embodiments are shown in the drawings, where the same or similar elements or the elements having same or similar functions are denoted by the same or similar reference numerals throughout the description. The embodiments described below with reference to the drawings are examples to explain the present disclosure, and shall not be construed as limitation of the present disclosure.

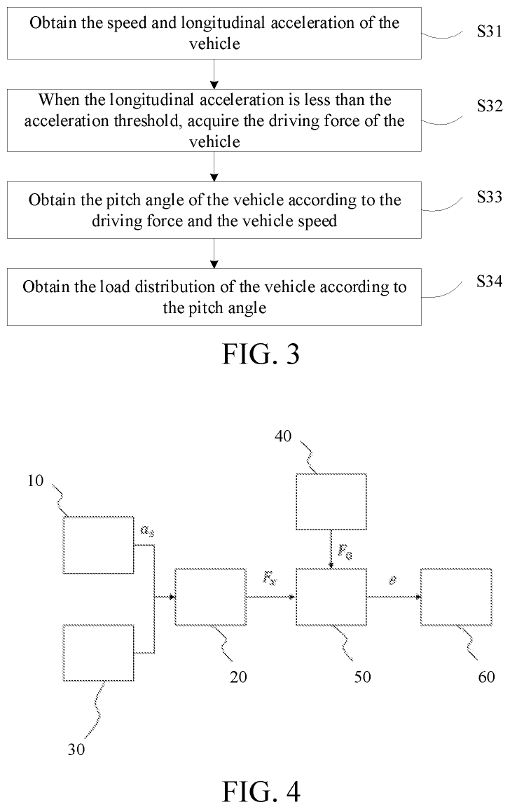

The vehicle and the vehicle load distribution identification method and apparatus and the medium and electronic device according to embodiments of the present disclosure will be described below with reference to FIGS. 3-10.

First, the principle of vehicle load distribution identification according to the embodiment of the present disclosure will be explained.

As shown in FIG. 5, the front axle load F₁ and the rear axle load F₂ are applied to the front and rear suspensions respectively, which changes the height of the suspensions, thus causing the change of the pitch angle. Based on this principle, the difference between the front axle load and the rear axle load can be estimated according to the change of the pitch angle.

In an embodiment, the stiffness of the front suspension k₁, the stiffness of the rear suspension k₂ and the front-rear wheelbase L of the vehicle are acquired from the vehicle parameters, so the relation between the front-rear axle loads and the pitch angle θ is:

$$θ = \frac{{F}_{2} / {k}_{2} - {F}_{1} / {k}_{1}}{L} .$$

As an example, if the stiffnesses of the front and rear suspensions are approximately equal and assumed as k, the pitch angle θ and the difference between the front and rear axle loads ΔF can be simplified as a direct proportion relation:

$$θ = \frac{Δ F}{kL} .$$

Therefore, the difference between the front and rear axle loads can be obtained by estimating the pitch angle.

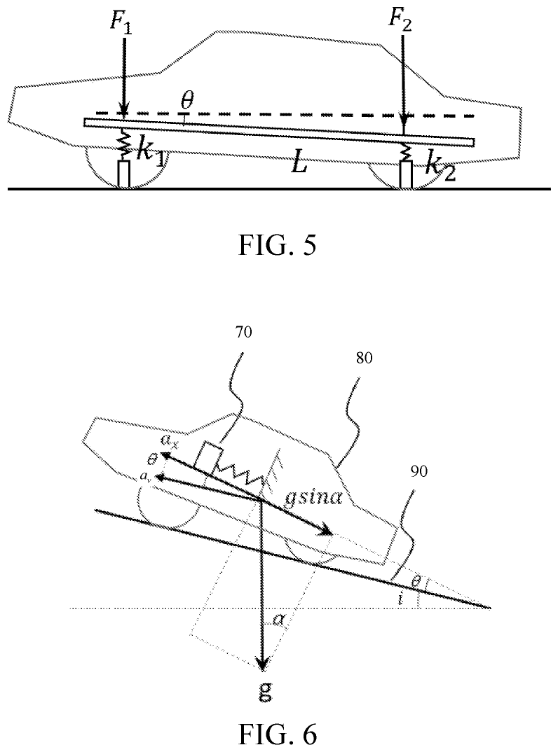

FIG. 6 shows the measurement of the acceleration sensor versus the longitudinal acceleration of the vehicle. Referring to FIG. 6, when the vehicle travels on a road 90 with a certain slope, the acceleration sensor 70 is fixed on the vehicle body 80, so its levelness in the longitudinal direction (vehicle traveling direction) is affected jointly by the pitch angle and the road slope. In FIG. 6, α is the longitudinal included angle between the inertia component of the acceleration sensor and the horizontal plane, the road slope angle is i, and the pitch angle of the vehicle is θ, then the relation between the angles is: α=θ+i.

As the acceleration sensor is not kept horizontal, the longitudinal acceleration aₛ measured by it includes the components of the longitudinal acceleration of the vehicle aᵥ and the acceleration of gravity in the measurement direction of the sensor: aₛ=aᵥ cos θ+g sin α.

The above equation can be approximated as: aₛ=aᵥ+gi+gθ

The longitudinal dynamic equation during the travel of the vehicle is as follows:

Fₜ=F_{w}+F_{f}+mgi+δmaᵥ,

where Fₜ is the driving force, F_{w} is the air resistance, F_{f} is the rolling resistance, m is the mass of the vehicle, g is the acceleration of gravity, i is the slope and δ is the conversion coefficient of rotating mass. At a higher gear (lower speed ratio), the conversion coefficient of rotating mass is close to 1. At this time, the longitudinal dynamic equation of the vehicle is simplified as:

Fₜ=F_{w}+F_{f}+m(aᵥ+gi).

Substituting the acceleration aₛ measured by the acceleration sensor into the above equation, we can obtain:

Fₜ=F_{w}+F_{f}+m(aₛ−gθ).

When aₛ=0, we can obtain the following from the equation above:

Fₜ=F_{w}+F_{f}+mgθ.

Because the relation between the rolling resistance F_{f} and the vehicle speed is weak, and the relation between the air resistance F_{w} and the vehicle speed is approximately quadratic, and its coefficient (that is, the air resistance coefficient) is only related to the shape of the vehicle, the difference in rolling resistance can be ignored, and it can be considered that the same vehicle with different loads experiences the same resistance F_{w}+F_{f} when the vehicle speed is the same or similar. Therefore, the difference in pitch angle of the same vehicle traveling at the same speed in different load conditions can be calculated by the following equation (where F_{t,1} is the driving force in load condition 1 when aₛ=0; and F_{t,2} is the driving force in load condition 2 when aₛ=0):

$$Δ θ = \frac{{F}_{t , 1} {\vert}_{{a}_{s} = 0} - {F}_{t , 2} {\vert}_{{a}_{s} = 0}}{mg} .$$

Based on the foregoing principle, the present disclosure provides a vehicle load distribution identification method. FIG. 3 is a flowchart of a vehicle load distribution identification method according to an embodiment of the present disclosure.

It should be noted that before performing this vehicle load distribution identification method, the model of correspondence between the load distribution and the reference driving force F₀ and the reference pitch angle θ₀ needs to be calibrated. In an embodiment, the reference driving force F₀ and the reference pitch angle θ₀ can be calibrated when the vehicle is in a state with a known load distribution.

In an embodiment, a time interval can be set, and when the vehicle is controlled to run at various vehicle speeds, the acceleration sensor 10 acquires the longitudinal acceleration at the set time interval. Then, a driving force statistical calculation module 30 (which may be a recursive least square (RLS), Kalman filter, or other filters) calculates the driving force corresponding to the longitudinal acceleration measurement (approximation) less than the acceleration threshold, and the driving force can be obtained by multiplying the torque output by the power source (the driving motor of the vehicle) by the speed ratio of the transmission system; Then it can calculate the average of the driving forces to obtain the reference driving force corresponding to each vehicle speed. In an embodiment, N driving forces can be selected to calculate the average, where N is an integer greater than 1 and may assume a value of 3, 4, 5, etc. The acceleration threshold can be calibrated according to experiments, and the acceleration threshold can be different for different vehicle models.

The reference driving force F₀ output by the driving force statistical calculation module 30 can be stored in different units of the storage module 40 divided based on the vehicle speeds according to the current vehicle speed. Meanwhile, the reference pitch angle data θ₀ calculated (or directly measured) according to the current load distribution can also be stored in the storage module 40.

As shown in FIG. 3, the vehicle load distribution identification method includes the following steps.

S31: the speed and longitudinal acceleration of the vehicle are detected and obtained.

In an embodiment, the longitudinal acceleration aₛ of the vehicle can be detected and collected by the acceleration sensor 10 shown in 4, and the vehicle speed can be collected by the vehicle speed sensor, where both the acceleration sensor and the vehicle speed sensor can be installed on the vehicle body. In an embodiment, the vehicle speed can also be calculated based on the wheel speed of the vehicle, and the wheel speed can be collected by the wheel speed sensor installed on the wheel.

S32: When the longitudinal acceleration is less than the acceleration threshold, the driving force of the vehicle is acquired.

As an implementation, referring to FIG. 4, the acceleration sensor 10 can collect the longitudinal acceleration aₛ at a certain time interval. The driving force statistical calculation module 30 can calculate the driving force corresponding to the longitudinal acceleration aₛ that is less than the acceleration threshold, and the driving force can be calculated by multiplying the torque output by the driving motor of the vehicle by the speed ratio of the transmission system. In an embodiment, the driving force of the vehicle can be acquired once every time it is determined that the longitudinal acceleration is less than the acceleration threshold.

S33: the pitch angle of the vehicle is obtained according to the driving force and the vehicle speed.

As an implementation, the obtaining the pitch angle of the vehicle according to the driving force and the vehicle speed can include: obtaining the corresponding reference driving force according to the vehicle speed and acquiring the reference pitch angle; and obtaining the pitch angle according to the driving force, the reference driving force and the reference pitch angle. The preset value can be calibrated as required.

In this implementation, the obtaining the pitch angle according to the driving force, the reference driving force and the reference pitch angle can include: calculating a difference between the reference driving force and the driving force; acquiring the mass of the vehicle and calculating a ratio of the difference to the mass; and summing the ratio with the reference pitch angle to obtain the pitch angle.

In an embodiment, referring to FIG. 4, the driving force statistical calculation module 30 can output the driving force to the pitch angle calculation module 50, and the pitch angle calculation module 50 compares the driving force F with the reference driving force F₀ corresponding to the current vehicle speed in the storage module 40 and calculates the pitch angle θ of the vehicle according to the following equation:

$$θ = {θ}_{0} + \frac{{F}_{0} - F}{mg} ,$$

where θ₀ is the reference pitch angle, which can be obtained from the storage module 40; m is the mass of the vehicle; and g is the acceleration of gravity.

In this implementation, the obtaining the pitch angle according to the driving force, the reference driving force and the reference pitch angle can also include: calculating an average of multiple driving forces to obtain an average driving force; calculating a difference between the reference driving force and the average driving force; acquiring the mass of the vehicle and calculating a ratio of the difference to the mass; and summing the ratio with the reference pitch angle to obtain the pitch angle.

In an embodiment, the average driving force can be calculated within a certain period of time. For example, counting is started when it is determined that the longitudinal acceleration is less than the acceleration threshold, and the longitudinal acceleration is continuously monitored/detected. If all the longitudinal accelerations are less than the acceleration threshold within a preset time, or the proportion of the longitudinal accelerations less than the acceleration threshold is greater than a certain value, the average of all the driving forces obtained within the preset time is calculated to obtain the average driving force. The average driving force can also be calculated by statistically counting the number of the driving forces. For example, every time it is determined that the longitudinal acceleration is less than the acceleration threshold, an driving force is obtained. When the number of the driving forces reaches a preset value, the average of the preset number of driving forces is calculated to obtain the average driving force. Referring to FIG. 4, after obtaining multiple driving forces, the driving force statistical calculation module 30 can further calculate the average of the driving forces Fₓ. The pitch angle calculation module 50 compares the average of the driving forces Fₓ output by the driving force statistical calculation module 30 with the reference driving force F₀ corresponding to the current vehicle speed in the storage module 40, and calculates the pitch angle θ of the vehicle according to the following equation:

$$θ = {θ}_{0} + \frac{{F}_{0} - {F}_{x}}{mg} ,$$

where θ₀ is the reference pitch angle, which can be obtained from the storage module 40; m is the mass of the vehicle; and g is the acceleration of gravity.

S34: the load distribution of the vehicle is obtained according to the pitch angle.

As an implementation, the obtaining the load distribution of the vehicle according to the pitch angle can include: acquiring a front-rear wheelbase, the stiffness of a front suspension and the stiffness of a rear suspension of the vehicle; and calculating the load distribution of the vehicle according to the pitch angle, the front-rear wheelbase, the stiffness of the front suspension and the stiffness of the rear suspension.

In an embodiment, referring to FIG. 4, the load distribution meter module 60 can calculate the front-rear load distribution of the vehicle according to the pitch angle θ output by the pitch angle calculation module 50 and the pre-stored vehicle information (including the front-rear wheelbase, the stiffness of the front suspension and the stiffness of the rear suspension). In an embodiment, the load distribution of the vehicle can be calculated by the following equation:

$$θ = \frac{{F}_{2} / {k}_{2} - {F}_{1} / {k}_{1}}{L} ,$$

where θ is the pitch angle, L is the front-rear wheelbase, k₁, k₂ are respectively the stiffness of the front suspension and the stiffness of the rear suspension, and F₁, F₂ are respectively the front axle load and the rear axle load of the vehicle.

In an embodiment, the obtained static load distribution of the front and rear axles of the vehicle can be used to improve the performance of the following systems: the Antilock Brake System (ABS), the Electronic Stability Program (ESP), the Traction Control System (TCS), the Electric Brakeforce Distribution (EBD), the active suspension Active Body Control (ABC), Anti Rolling Program (ARP), headlight range control, tire pressure monitoring, and the like.

With the vehicle load distribution identification method according to the embodiment of the present disclosure, the vehicle load is not directly measured, instead, the pitch angle of the vehicle is estimated and then the difference between the front axle and rear axle loads can be calculated according to the statics knowledge. As such, the vehicle load distribution can be identified without installing dedicated sensors such as a load sensor and a vehicle body height sensor at the vehicle suspension, which reduces the cost of vehicle load distribution identification and allows a wide range of applications without being limited by the vehicle model.

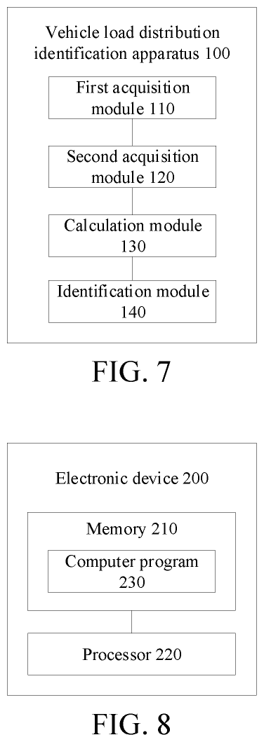

FIG. 7 is a structural block diagram of a vehicle load distribution identification apparatus according to an embodiment of the present disclosure.

As shown in FIG. 7, the vehicle load distribution identification apparatus 100 includes: a first acquisition module 110, a second acquisition module 120, a calculation module 130 and an identification module 140.

The first acquisition module 110 is configured to acquire/detect a speed and longitudinal acceleration of the vehicle; the second acquisition module 120 is configured to acquire, through statistical calculation, an driving force of the vehicle when the longitudinal acceleration is less than an acceleration threshold; the calculation module 130 is configured to obtain an pitch angle of the vehicle according to the driving force and vehicle speed; and the identification module 140 is configured to obtain load distribution of the vehicle according to the pitch angle.

As an implementation, the calculation module 130 is configured to: when the number of driving forces acquired by the second acquisition module 120 reaches a preset value, calculate the average of the preset number of driving forces to obtain the average driving force; obtain the corresponding reference driving force according to the vehicle speed and obtain a reference pitch angle; and obtain the pitch angle according to the average driving force, the reference driving force and the reference pitch angle.

The calculation module 130 is configured to, in obtaining the pitch angle according to the average driving force and the reference driving force: calculate a difference between the reference driving force and the average driving force; acquire the mass of the vehicle and calculating a ratio of the difference to the mass; and summing the ratio with the reference pitch angle to obtain the pitch angle.

As an implementation, the identification module 140 is configured to: acquire a front-rear wheelbase, the stiffness of a front suspension and the stiffness of a rear suspension of the vehicle; and calculate the load distribution of the vehicle according to the pitch angle, the front-rear wheelbase, the stiffness of the front suspension and the stiffness of the rear suspension.

In an embodiment, the load distribution of the vehicle can be calculated by the following equation:

$$θ = \frac{{F}_{2} / {k}_{2} - {F}_{1} / {k}_{1}}{L} ,$$

where θ is the pitch angle, L is the front-rear wheelbase, k₁, k₂ are respectively the stiffness of the front suspension and the stiffness of the rear suspension, and F₁, F₂ are respectively the front axle load and the rear axle load of the vehicle.

It should be noted that, for some implementations of the vehicle load distribution identification apparatus 100 according to the embodiment of the present disclosure, reference may be made to the implementations of the vehicle load distribution identification method of the above embodiment of the present disclosure.

With the vehicle load distribution identification apparatus 100 according to the embodiment of the present disclosure, the vehicle load distribution can be identified without installing dedicated sensors such as a load sensor and a vehicle body height sensor at the vehicle suspension, which reduces the cost of vehicle load distribution identification and allows a wide range of applications without being limited by the vehicle model.

The present disclosure provides a computer-readable storage medium.

In this embodiment, the computer-readable storage medium (e.g., the non-transitory computer-readable storage medium) has a computer program stored thereon, which, when executed by a processor, implements the vehicle load distribution identification method described above.

With the computer-readable storage medium according to the embodiment of the present disclosure, when the computer program stored thereon for the vehicle load distribution identification method described above is executed by a processor, the vehicle load distribution can be identified without installing dedicated sensors such as a load sensor and a vehicle body height sensor at the vehicle suspension, which reduces the cost of vehicle load distribution identification and allows a wide range of applications without being limited by the vehicle model.

In an embodiment, the present disclosure further provides an electronic device.

In this embodiment, as shown in FIG. 8, the electronic device 200 includes a memory 210 and a processor 220. The memory 210 has a computer program 230 stored thereon, which, when executed by the processor 220, implements the vehicle load distribution identification method described above.

With the electronic device 200 according to the embodiment of the present disclosure, when the computer program 230 stored in the memory 210 thereof for the vehicle load distribution identification method described above is executed by the processor 220, the vehicle load distribution can be identified without installing dedicated sensors such as a load sensor and a vehicle body height sensor at the vehicle suspension, which reduces the cost of vehicle load distribution identification and allows a wide range of applications without being limited by the vehicle model.

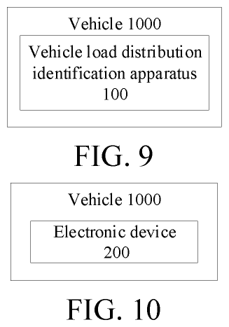

FIG. 9 is a structural block diagram of a vehicle according to an embodiment of the present disclosure.

As shown in FIG. 9, the vehicle 1000 includes the vehicle load distribution identification apparatus 100 according to the embodiment described above.

FIG. 10 is a structural block diagram of a vehicle according to another embodiment of the present disclosure.

As shown in FIG. 10, the vehicle 1000 includes the electronic device 200 according to the embodiment described above.

With the vehicle according to the embodiment described above, by use of the vehicle load distribution identification apparatus 100 or the electronic device 200 described above, it is not necessary to install dedicated sensors such as a load sensor and a vehicle body height sensor at the vehicle suspension, which reduces the cost of vehicle load distribution identification and allows a wide range of applications without being limited by the vehicle model.

It should be noted that the logic and/or steps shown in the flowcharts or described in any other manner herein, for example, a sequenced list that may be considered as executable instructions for implementing logical functions, may be embodied in any computer-readable medium to be used by an instruction execution system, apparatus, or device (for example, a computer-based system, a system including a processor, or another system that can fetch an instruction from the instruction execution system, apparatus, or device and execute the instruction) or to be used in combination with such instruction execution systems, apparatuses, or devices. In this specification, the term “computer-readable medium” may be any apparatus that can contain, store, communicate, propagate, or transmit programs to be used by the instruction execution system, apparatus or device or to be used in combination with such instruction execution systems, apparatuses or devices. More examples (a non-exhaustive list) of the computer-readable medium include: an electrical connection part (electronic device) having one or more wires, a portable computer diskette (magnetic apparatus), a random access memory (RAM), a read-only memory (ROM), an erasable programmable read-only memory (EPROM or flash memory), an optical fiber apparatus, and a portable compact disk read-only memory (CDROM). In addition, the computer-readable medium can even be paper or other suitable media on which the program can be printed, because the program can be obtained electronically by, for example, optically scanning the paper or other media, then editing, interpreting, or processing in other suitable ways if necessary, and then storing it in a computer memory.

It should be understood that, various parts of the present disclosure can be implemented in hardware, software, firmware, or a combination thereof. In the foregoing implementations, multiple steps or methods may be implemented by using software or firmware that are stored in a memory and executed by a proper instruction execution system. For example, if implementation is made in hardware, as in another implementation, implementation may be realized by any one of the following technologies well known in the art or a combination thereof: a discrete logic circuit including a logic gate circuit for implementing a logic function for a data signal, a dedicated integrated circuit including a proper combined logic gate circuit, a programmable gate array (PGA), a field programmable gate array (FPGA), and the like.

In the descriptions of this specification, descriptions of a reference term such as “an embodiment,” “some embodiments,” “an example,” “a specific example,” or “some examples” means that a specific feature, structure, material, or characteristic that is described with reference to the embodiment or the example is included in at least one embodiment or example of the present application. In this specification, expressions of the foregoing terms do not necessarily refer to the same embodiment or example. In addition, the described features, structures, materials, or characteristics may be combined in a proper manner in any one or more of the embodiments or examples.

In the description of the present disclosure, it should be understood that orientation or position relations indicated by the terms such as “center”, “longitudinal”, “transverse”, “length”, “width”, “thickness”, “above”, “below”, “front”, “back”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relations shown in the drawings, and are used merely for ease and brevity of illustration and description, rather than indicating or implying that the mentioned apparatus or element must have a particular orientation or must be constructed and operated in a particular orientation. Therefore, such terms should not be construed as limitation of the present disclosure.

In addition, the terms “first” and “second” are used merely for the purpose of description, and shall not be construed as indicating or implying relative importance or implying a quantity of indicated technical features. Therefore, a feature defined by the term “first” or “second” may explicitly indicate or implicitly include at least one of such features. In description of the present disclosure, the term “multiple” means at least two, such as two and three, unless it is specifically defined otherwise.

In the present disclosure, unless otherwise explicitly specified or defined, the terms such as “install”, “joint”, “connect”, and “fix” should be understood in a broad sense. For example, the connection may be a fixed connection, a detachable connection, or an integral connection; or the connection may be a mechanical connection or an electrical connection; or the connection may be a direct connection, an indirect connection through an intermediary medium, or internal communication between two elements or mutual reaction relation between two elements, unless otherwise explicitly specified. A person of ordinary skill in the art may understand the meanings of the foregoing terms in the present disclosure according to contexts.

In the present disclosure, unless otherwise explicitly specified or defined, the first feature being located “above” or “below” the second feature may indicate the first feature is in direct contact with the second feature, or the first feature is in indirect contact with the second feature through an intermediary medium. In addition, the first feature being “above”, “over”, or “on” the second feature may indicate that the first feature is directly above or obliquely above the second feature, or may merely indicate that the horizontal position of the first feature is higher than that of the second feature. The first feature being “below”, “under”, and “beneath” the second feature may indicate that the first feature is right below the second feature or obliquely below the second feature, or may merely indicate that the horizontal position of the first feature is lower than that of the second feature.

Although the embodiments of the present disclosure have been shown and described above, it can be understood that the above embodiments are some of the embodiments and should not be understood as limitation of the present disclosure. A person of ordinary skill in the art can make changes, modifications, replacements, or variations to the above embodiments within the scope of the present disclosure.

What is claimed is:

1. A method for identifying vehicle load distribution, comprising:
detecting a vehicle speed and longitudinal acceleration of a vehicle;
acquiring a driving force of the vehicle when the longitudinal acceleration is less than an acceleration threshold;
obtaining, by a processor, a pitch angle of the vehicle according to the driving force and the vehicle speed; and
obtaining, by the processor, load distribution of the vehicle according to the pitch angle.

2. The method of claim 1, wherein the obtaining, by a processor, an pitch angle of the vehicle according to the driving force and the vehicle speed comprises:
obtaining a reference driving force corresponding to the vehicle speed according to the vehicle speed, and acquiring a reference pitch angle; and
obtaining the pitch angle according to the driving force, the reference driving force, and the reference pitch angle.

3. The method of claim 2, wherein the obtaining the pitch angle according to the driving force, the reference driving force, and the reference pitch angle comprises:
calculating a first difference between the reference driving force and the driving force;
acquiring a mass of the vehicle, and calculating a first ratio of the first difference to the mass; and
summing the first ratio with the reference pitch angle to obtain the pitch angle.

4. The method of claim 2, wherein the obtaining the pitch angle according to the driving force, the reference driving force, and the reference pitch angle comprises:
calculating an average of a plurality of driving forces to obtain an average driving force;
calculating a second difference between the reference driving force and the average driving force;
acquiring a mass of the vehicle and calculating a second ratio of the second difference to the mass; and
summing the second ratio with the reference pitch angle to obtain the pitch angle.

5. The method of claim 1, wherein the obtaining, by the processor, load distribution of the vehicle according to the pitch angle comprises:
acquiring a front-rear wheelbase, a stiffness of a front suspension, and a stiffness of a rear suspension of the vehicle; and
calculating the load distribution of the vehicle according to the pitch angle, the front-rear wheelbase, the stiffness of the front suspension, and the stiffness of the rear suspension.

6. The method of claim 5, wherein the load distribution of the vehicle is calculated by an equation:
$$θ = \frac{{F}_{2} / {k}_{2} - {F}_{1} / {k}_{1}}{L} ,$$
wherein θ is the pitch angle, L is the front-rear wheelbase, k₁ is the stiffness of the front suspension, k₂ is the stiffness of the rear suspension, and F₁ is a front axle load, and F₂ is a rear axle load of the vehicle.

7. A non-transitory computer-readable storage medium storing a computer program, wherein, when the computer program is executed by a processor, the computer program causes the processor to perform operations comprising:
detecting a vehicle speed and longitudinal acceleration of a vehicle;
acquiring a driving force of the vehicle when the longitudinal acceleration is less than an acceleration threshold;
obtaining a pitch angle of the vehicle according to the driving force and the vehicle speed; and
obtaining load distribution of the vehicle according to the pitch angle.

8. The medium of claim 7, wherein the obtaining a pitch angle of the vehicle according to the driving force and the vehicle speed comprises:
obtaining a reference driving force corresponding to the vehicle speed according to the vehicle speed, and acquiring a reference pitch angle; and
obtaining the pitch angle according to the driving force, the reference driving force, and the reference pitch angle.

9. The medium of claim 8, wherein the obtaining the pitch angle according to the driving force, the reference driving force, and the reference pitch angle comprises:
calculating a first difference between the reference driving force and the driving force;
acquiring a mass of the vehicle, and calculating a first ratio of the first difference to the mass; and
summing the first ratio with the reference pitch angle to obtain the pitch angle.

10. The medium of claim 8, wherein the obtaining the pitch angle according to the driving force, the reference driving force, and the reference pitch angle comprises:
calculating an average of a plurality of driving forces to obtain an average driving force;
calculating a second difference between the reference driving force and the average driving force;
acquiring a mass of the vehicle and calculating a second ratio of the second difference to the mass; and
summing the second ratio with the reference pitch angle to obtain the pitch angle.

11. The medium of claim 7, wherein the obtaining load distribution of the vehicle according to the pitch angle comprises:
acquiring a front-rear wheelbase, a stiffness of a front suspension, and a stiffness of a rear suspension of the vehicle; and
calculating the load distribution of the vehicle according to the pitch angle, the front-rear wheelbase, the stiffness of the front suspension, and the stiffness of the rear suspension.

12. The medium of claim 11, wherein the load distribution of the vehicle is calculated by an equation:
$$θ = \frac{{F}_{2} / {k}_{2} - {F}_{1} / {k}_{1}}{L} ,$$
wherein θ is the pitch angle, L is the front-rear wheelbase, k₁ is the stiffness of the front suspension, k₂ is the stiffness of the rear suspension, and F₁ is a front axle load, and F₂ is a rear axle load of the vehicle.

13. An electronic device for identifying vehicle load distribution, comprising a memory and a processor, the memory storing a computer program, wherein when the computer program is executed by a processor, the computer program causes the processor to perform operations comprising:
detecting a vehicle speed and longitudinal acceleration of a vehicle;
acquiring a driving force of the vehicle when the longitudinal acceleration is less than an acceleration threshold;
obtaining a pitch angle of the vehicle according to the driving force and the vehicle speed; and
obtaining load distribution of the vehicle according to the pitch angle.

14. The device of claim 13, wherein the obtaining a pitch angle of the vehicle according to the driving force and the vehicle speed comprises:
obtaining a reference driving force corresponding to the vehicle speed according to the vehicle speed, and acquiring a reference pitch angle; and
obtaining the pitch angle according to the driving force, the reference driving force, and the reference pitch angle.

15. The device of claim 14, wherein the obtaining the pitch angle according to the driving force, the reference driving force, and the reference pitch angle comprises:
calculating a first difference between the reference driving force and the driving force;
acquiring a mass of the vehicle, and calculating a first ratio of the first difference to the mass; and
summing the first ratio with the reference pitch angle to obtain the pitch angle.

16. The device of claim 14, wherein the obtaining the pitch angle according to the driving force, the reference driving force, and the reference pitch angle comprises:
calculating an average of a plurality of driving forces to obtain an average driving force;
calculating a second difference between the reference driving force and the average driving force;
acquiring a mass of the vehicle and calculating a second ratio of the second difference to the mass; and
summing the second ratio with the reference pitch angle to obtain the pitch angle.

17. The device of claim 13, wherein the obtaining load distribution of the vehicle according to the pitch angle comprises:
acquiring a front-rear wheelbase, a stiffness of a front suspension, and a stiffness of a rear suspension of the vehicle; and
calculating the load distribution of the vehicle according to the pitch angle, the front-rear wheelbase, the stiffness of the front suspension, and the stiffness of the rear suspension.

18. The device of claim 17, wherein the load distribution of the vehicle is calculated by an equation:
$$θ = \frac{{F}_{2} / {k}_{2} - {F}_{1} / {k}_{1}}{L} ,$$
wherein θ is the pitch angle, L is the front-rear wheelbase, k₁ is the stiffness of the front suspension, k₂ is the stiffness of the rear suspension, and F₁ is a front axle load, and F₂ is a rear axle load of the vehicle.

19. A vehicle, comprising:
the electronic device for identifying vehicle load distribution of claim 13.
